(19) United States
(12) Patent Application Publication
(10) Pub. No.: US 2025/0067837 A1
(43) Pub. Date: Feb. 27, 2025

(54) Verfahren und Radar-Messvorrichtung zur Detektion von Unregelmäßigkeiten in Messobjekten

(71) Applicant: CiTEX Holding GmbH, Melle (DE)

(72) Inventors: Marius THIEL, Osnabrück (DE); Juliane EGGERT, Osnabrück (DE)

(21) Appl. No.: 18/810,706

(22) Filed: Aug. 21, 2024

(30) Foreign Application Priority Data
Aug. 23, 2023 (DE) 10 2023 122 556.1
Sep. 19, 2023 (DE) 10 2023 125 354.9

(51) Int. Cl. G01S 7/02; G01N 22/02; G01S 7/35; G01S 7/41; G01S 13/88

(52) U.S. Cl. CPC G01S 7/024; G01N 22/02; G01S 7/35; G01S 13/88; G01S 7/411

(57) ABSTRACT

The present disclosure relates a method and a radar measuring device for detecting irregularities in measured objects, in particular, extruded products, where a frequency modulated first radar radiation having a first polarization is generated and irradiated along an optical axis onto a measured object, and a frequency modulated second radar radiation having a second polarization reflected and/or transmitted by the measured object is detected, and irregularities in the measured object are determined from a comparison of the second polarization with the first polarization. Hereby, in particular, a change of the ratio of the radiation in different polarizations may be evaluated.

The invention relates to a method and a radar measuring device for detecting irregularities in measured objects, in particular, extruded products. Measured objects may exhibit various irregularities. In the process of extruding plastic products irregularities may appear in the extruded product, e.g., defects, changes in material and surfaces, material tensions or inclusions, e.g., air pockets or impurities, which may lead to an impaired extruded product. Furthermore, irregularities may also appear upon cooling off the extruded product, e.g., by tensions building up in the material or on the surface.

In this respect a measured object, e.g., an extruded product, may be evaluated, for one thing, optically, e.g., by means of a camera. Further, THz measuring methods and THz measuring devices are known, wherein the layer thickness of the measured object is determined first, and further, irregularities, e.g., shrinkage cavities, can be extrapolated from scatter radiation in the measurement signal. Smaller changes, e.g., including material tensions, cannot be easily determined in this way, however.

The document DE 10 2020 123 992 A1 describes a THz measuring device and a corresponding measuring method for measuring tested objects, in particular, pipes, wherein THz transceivers are arranged opposite one another sharing the same optical axis and emit radiation in different planes of polarization, where additionally reflectors for selectively reflecting the different polarizations are provided so that two measuring devices are arranged on a common axis while not interacting with one another.

The citation US 2022/0026372 A1 shows a method for detecting defects in front side welded joints of pipes by means of pulsed Terahertz radiation. Hereby, pulsed THz radiation is irradiated from a transmitter into the region of the welded joint, and the reflected pulsed THz radiation is detected by a receiver, where polarization filters may be arranged in front of the transmitter and the receiver, so as to establish tensions in the pipe.

It is the object of the invention to create a method and a radar measuring device for detecting irregularities allowing for the determination of irregularities in measured objects with little effort.

This task is solved by a method and a radar measuring device according to the independent claims. Further, a measuring arrangement made of the radar measuring device and the measured object are provided. Preferred further developments are described in the sub-claims.

Thus, a method for detecting irregularities in measured objects is created, wherein frequency modulated first radar radiation, in particular, FMCW radar radiation, with a first polarization, in particular, is first generated and irradiated along an optical axis onto a measured object, the measured object being at least partially permeable to the radar radiation, e.g., made from plastics or rubber, and frequency modulated second radar radiation with a second polarization reflected from the measured object and/or transmitted is detected, and irregularities in the measured object are determined from a comparison of the second polarization with the first polarization and/or a comparison of the radiation or, respectively, intensity of the radiation of the second and first polarization.

Thus, radar radiation with a first polarization is irradiated onto a surface of the measured object and radar radiation with a second polarization reflected from the measured object on its surface and/or transmitted through the measured object is detected, and the polarization or, respectively, change in polarization of the emitted and detected radiation is evaluated. This method is based on the finding that irregularities in a measured object, in particular, an extruded product, may also influence the polarization, or the irregularity behaves differently in relation to radiation of a different polarization than other areas of the measured object. Thus, a comparison of the polarizations before and after impinging on the measured object can provide clues relating to the irregularities, in particular, by means of a comparison with previous measurements in the other regions without the irregularity.

Thus, upon reflection and transmission on irregularities such as defects, changes in material and on surfaces, and material tensions the polarization is affected generally. In particular, depending on the angle of incidence on the surface the degree of the reflection and/or transmission of a polarized radiation is altered. Thus, in particular, radiation of a first polarization may be reflected and transmitted better or worse reflected and transmitted than the radiation of the second polarization orthogonal there to.

It is apparent, in particular, that measuring an extruded object, in particular, a plastic pipe or a plastic strand, after the extrusion, allows for precise analyses. Thus, impurities and defects in or on the walls may be detected in the partially still soft material. Thus, in contrast to the citation US 2022/0026372 A1, in particular, an extruded pipe is consistently and continuously examined after extrusion by means of frequency modulated THz radiation, i.e., not only one welded joint for material tensions, in contrast to the document US 2022/0026372 A1, in which polarized radiation is used for detecting tensions, the invention allows for covering also inclusions and defects by the polarized radiation.

Besides the selective reflection and transmission, the irregularity may further cause a rotation of the polarization, in particular, exhibiting a different behavior than in regular areas of the measured object. Such a rotation, too, can be determined by virtue of the relation of the different polarizations in the detected radar radiation, in particular, by comparison with the emitted radiation.

The first polarization of the emitted first radiation and the second polarization of the reflected and/or transmitted second radiation may, in principle, each comprise components of several polarization planes, e.g., even with regular distribution in polarization planes orthogonal in relation to one another, or may even be polarized already.

Instead of the polarization in planes orthogonal in relation to one another, circularly or elliptically polarized radiation may be used, in which opposite directions of rotation form an orthogonal system. Thus, circularly or elliptically polarized first radar radiation may be emitted, and circularly or elliptically polarized reflected or transmitted radar radiation may be detected, and the irregularities may be extrapolated from a comparison of the directions of polarization, in particular, the levorotatory and dextrorotatory polarizations

A polarization specific influence generally happens already upon a reflection of the radar radiation on a regular surface depending on the angle of incidence. Thus, radar radiation incoming under a flatter angle of incidence will generally be reflected in the polarization perpendicular to the surface differently than radiation with a polarization parallel to the surface so that, e.g., a ratio of the radiations in the polarization planes can be evaluated. In the presence of irregularities these characteristics or, respectively, this ration may be significantly changed. Thus, the selective reflection may be attenuated by the irregularity, where both the previously better reflected radiation may be reflected worse as well as the previously poorly reflected radiation may be reflected better. Thus, the ratio of the polarizations, i.e., e.g., the ratio of the intensity of the radiation with perpendicular polarization to the intensity of the radiation with parallel polarization is highly sensitive for such irregularities.

Furthermore, it is also possible to evaluate the ratio of the emitted to the reflected and/or transmitted radiation for each of the two polarization planes.

When measuring in transmission the first radar radiation impinging upon the surface at an angle of incidence is diffracted upon entering the surface, generally towards the surface normal, because the measured object will generally exhibit a higher refractive index than the surrounding air, and upon exiting again diffracted away from the normal. In the case of transmission, too, the polarizations will be affected differently so that upon detecting the transmitted radiation corresponding evaluations will be carried out in turn. In particular, in the transmission it is possible to cover and evaluate regions outside the surface of the measured object, in particular, the entire volume of the measured object.

The radar measuring device comprises a first optical unit which includes a first optical unit and a second optical unit, the first optical unit emitting radiation, i.e., e.g., designed as an emitter and/or first transceiver, so as to emit radar radiation having a first polarization along a first optical axis, and the second optical unit receiving or reflecting the radiation so that it is designed, e.g., as a receiver and/or second transceiver and/or reflector, with a second optical axis.

The radiation emitted from the first transceiver along its first optical axis can, after reflection or transmission, subsequently be detected by a second transceiver the second optical axis of which is aligned in accordance with the geometry of the reflection and/or transmission; hereby, this arrangement made of two transceivers may also be operated alternatingly. When directly measuring the reflection or transmission by a transceiver a relatively strong signal can be generated. Moreover, a reflector may even be arranged such that it reflects the detected and/or transmitted radiation back so that the first transceiver subsequently detects the re-reflected radiation, the radar radiation the having passed twice through the detection area of the measured object. Such an embodiment is more cost effective, where possibly the signal is weaker than when utilizing two transceivers. Furthermore, combinations hereof are conceivable too, comprising detectors and reflectors for measuring both the transmission and the reflection.

According to an advantageous further development, all embodiments may include evaluating multiple reflections in the measured object. If the measured object has a layer with a first surface and a second surface parallel there to, reflections will appear in the measured object between the surfaces so that the incident radar radiation is first diffracted in the measured object and then partially reflected from the inside of the other surface. Such multiple reflections may be additionally detected and evaluated. Hereby, the invention recognizes that the signal amplitude of these multiple reflections are well detected due to the temporal delay in relation to the direct measurement of the reflected or transmitted, allowing for them to be specifically evaluated. Such multiple reflections react highly sensitively to irregularities so that changes can be well detected.

The irregularities can first be detected in qualitative terms, in that temporal changes in the transported measured object are recognized so that e.g., a corresponding signal is put out to indicate the irregularity. Furthermore, irregularities may also be evaluated and detected, e.g., by means of a comparison with reference measurements of corresponding irregularities, that are conducted in advance. Hereby, it is also possible to utilize self-learning algorithms or artificial intelligence storing and comparing previously recognized and detected irregularities and their associated measuring data.

The method according to the invention and the radar measuring device according to the invention are suitable, in particular, for measuring extruded products, in particular, made of plastics, preferably inside the extrusion line after the extrusion, because such extruded products are permeable to radar radiation and partial reflections appear on their boundary surfaces, also because corresponding irregularities occur in such extruded products, and the method according to the invention and the measuring device according to the invention also, advantageously, allow for a continuous measuring of an object guided through the measuring device along the direction of transport, as it happens in an extrusion line. Moreover, in extrusion lines radar measuring devices according to the invention are already utilized for the determination of layer thicknesses and refractive indices of the extruded products so that the additional functionality can be realized with little effort.

Aside from simple extruded products such as pipes, profiles and films, even complex extruded products can be measured, e.g., corrugated pipes exhibiting crests and troughs alternating in their direction of transport. In that case, the contouring shape of the corrugated pipe when transported through the measuring device leads to specific measuring signals, in particular, even to changes in the polarizations, because the angle of incidence of the radar beams on the contoured surface changes continuously. Thus, the position of crests and troughs can be detected already, and this can also be used, e.g., for controlling a downstream radar measuring device which can be aligned in a suitable manner.

According to an advantageous embodiment, the measuring arrangement further includes optical means affecting the polarizations. Hereby, e.g., a polarization filter may be provided in the first optical axis and/or in the second optical axis. This allows, in particular, even transceivers to be utilized which emit and detect the radar radiation in a non-specific manner, since the different polarizations are formed by the polarization filters. The polarization filters may be arranged in the optical axes with identical alignment or differently, e.g., to detect rotation in a more selective manner.

Furthermore, optically active means may be provided as optical means, e.g., optical means rotating the polarization, e.g., even retardation plates and equivalent means causing different delays in the polarizations. Thus, with the use of such means, specific evaluations are possible, with the cost of such additional optical means being low.

Furthermore, measurements are possible at different frequencies or, respectively, frequency ranges. When utilizing FMCW radar, where a frequency range is swept through or, respectively, scanned through, the individual frequency components can be specifically examined to allow for a frequency dependent evaluation of the reflection coefficient.

Furthermore, measurements are possible at different angles of incidence, where irregularities each lead to different reflection characteristics.

Thus, when utilized in an extrusion line or an extrusion process faults and irregularities can be directly detected, in respect whereof then e.g., an error signal or indicator signal is put out. Furthermore, regular changes appearing in the extruded product may be assessed, e.g., material tensions building up upon cooling, so that irregularities can be recognized in the build-up of the material tensions.

The frequency of the radar radiation may lie, in particular, in a range between 10 GHz and 50 THz, e.g., 50 GHz and 4 THz, e.g., 50 GHz and 1 THz, is generated and emitted by means of frequency modulation. As frequency modulation, in particular, FMCW (frequency modulated continuous wave) radar may be utilized. In the frequency modulation, in particular, a center frequency in a range between 80 and 700 GHz and e.g., a bandwidth between 50 and 100 GHz may be utilized.

It is apparent, in particular, that an FMCW radar allows for a cost-effective embodiment of the measuring device with selective examination of the individual frequency ranges. Thus, a low-cost chip or, respectively, integrated circuit with an FMCW oscillating circuit may be utilized, instead of the expensive state-of-the-art optical laser arrangement, yet achieving very good measuring results.

The invention is further illustrated below by means of the accompanying drawings by means of a few embodiments. It is shown in:

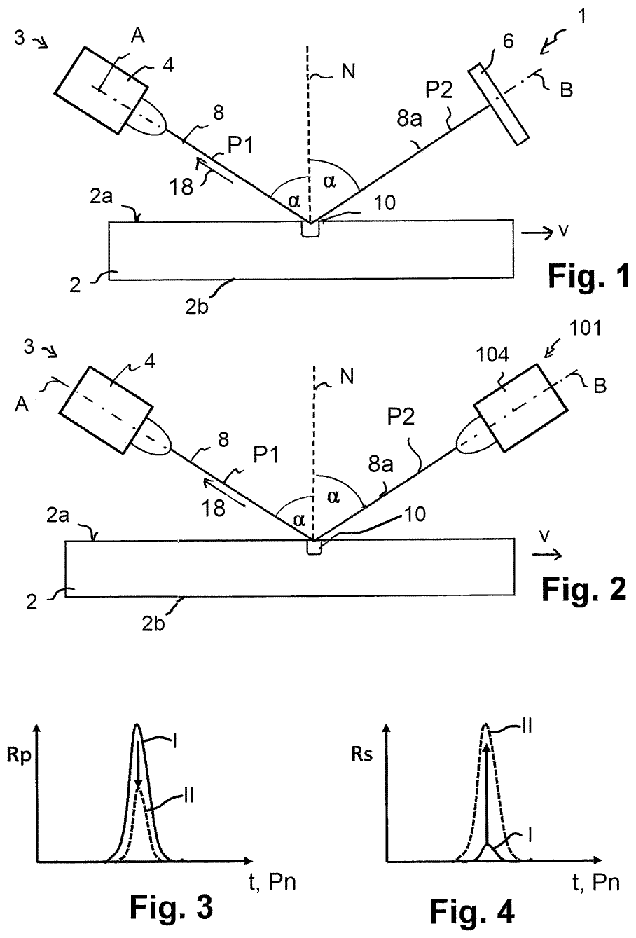

FIG. 1 a measuring arrangement for measuring an extruded product in reflection, including a reflector;

FIG. 2 a further embodiment for measuring an extruded product in reflection, including two transceivers;

FIG. 3 the changing of the component of the radiation with parallel polarization;

FIG. 4 the changing of the component of the radiation with perpendicular polarization;

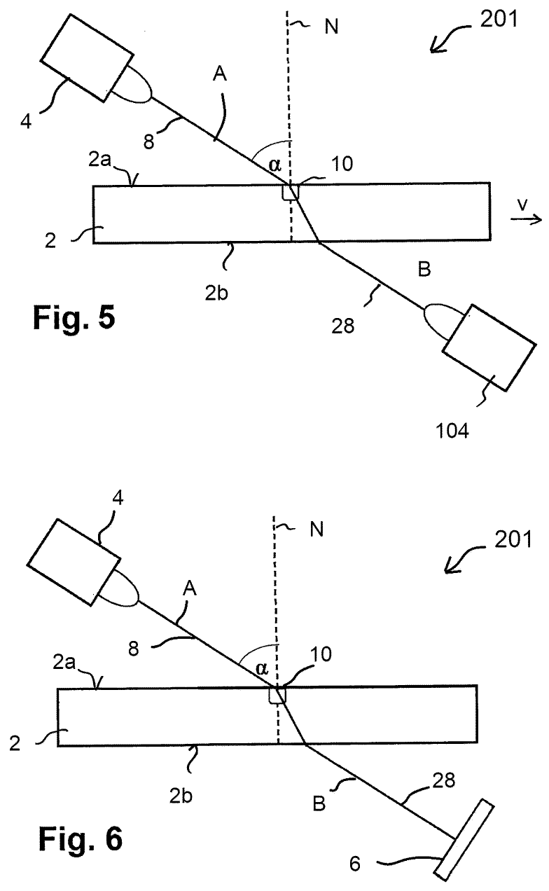

FIG. 5 a measuring arrangement in transmission including two transceivers;

FIG. 6 a measurement in transmission with transceiver and reflector;

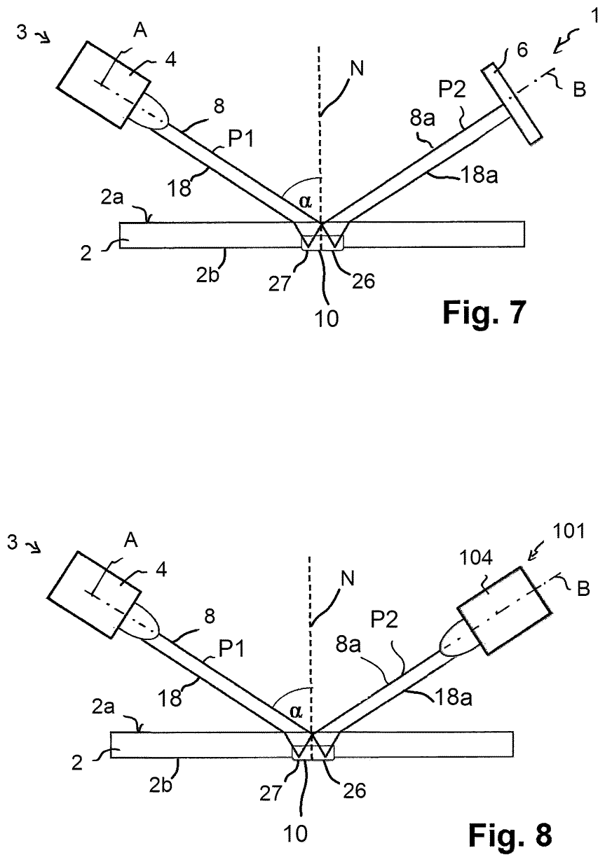

FIG. 7 the measuring arrangement of FIG. 1 considering the second reflection;

FIG. 8 the measuring arrangement of FIG. 2 considering the second reflection;

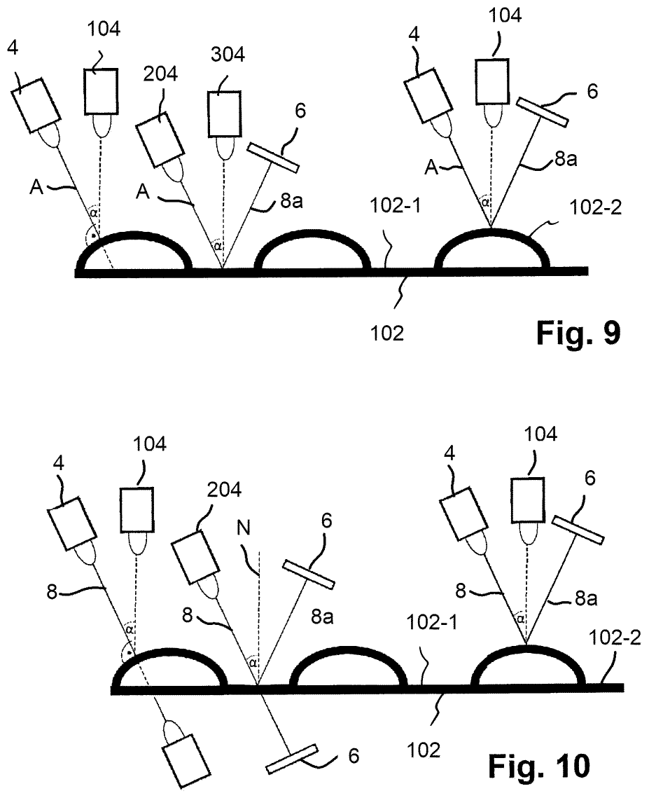

FIG. 9 a representation of the measurement of a corrugated pipe in reflection;

FIG. 10 a representation of the measurement of a corrugated pipe in reflection and transmission;

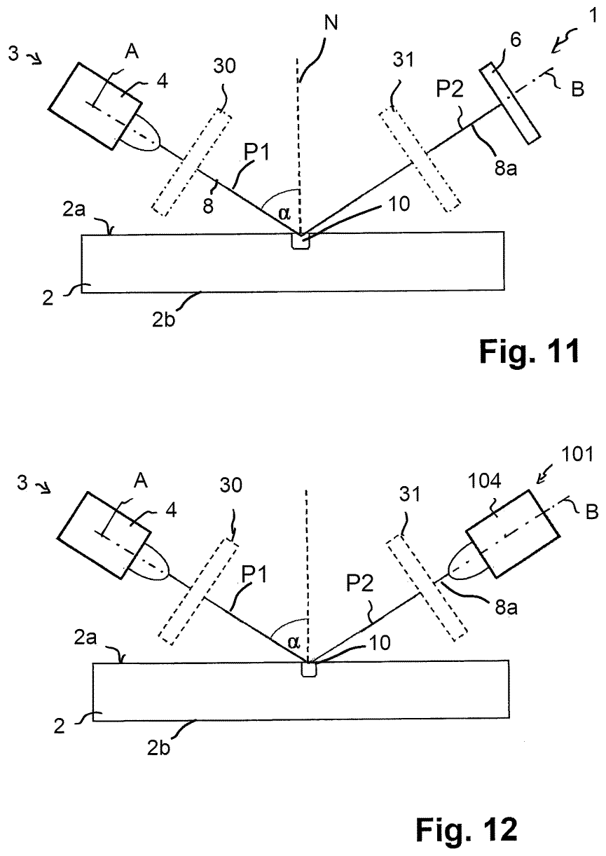

FIG. 11 a further measuring arrangement in reflection including additional optical means with a reflector;

FIG. 12 a representation corresponding to FIG. 11 including two transceivers.

FIG. 1 shows a measuring arrangement 1 consisting of an extruded product 2, e.g., a pipe or strand, which upon having been extruded is transported at a transport velocity v in its longitudinal direction. Thus, the extruded product 2 may, in particular, be measured directly upon being extruded, e.g., after a cooling bath. According to the embodiment of FIG. 1, a radar measuring device 3 comprises a radar transceiver 4 and a reflector 6. Here, the reflector 6 is represented as a planar mirror; it may also be, e.g., concavely curved. The extruded product 2 has a surface 2a, the normal N to which being drawn in accordingly. The radar transceiver 4 emits radar beams 8 along its optical axis A onto the surface 2a at an angle of incidence a in relation to the normal N so that the radar beams 8 are correspondingly reflected or partially reflected on the surface 2a and reach the reflector 6. The reflector 6 is aligned perpendicular to the second optical axis B which is aligned accordingly at the angle of incidence a in relation to the normal N so that the reflector 6 in turn reflects the reflected radar beams 8a back perpendicularly so that it is detected by the radar transceiver 4 following a new reflection on the surface 2a. Thus, a detection region of the extruded product 2 is measured in which the reflection measuring of FIGS. 1 and 2 is essentially realized on the surface 2a. Thus, because the extruded product 2 is continuously transported at the transport velocity v it is possible to continuously measure a part of the surface 2.

The emitted radar beam 8 has a first polarization P1. The first polarization P1 can be made without any specific alignment, or even as linear, elliptical or circular polarization. The reflected radar beam 8a has a second polarization P2 which is generally changed in relation to the first polarization P1. Thus, a reflection on the surface 2a, in particular, also depending on the angle of incidence a, leads to a different reflection of the polarization components of the emitted radar beam 8. Thus, depending on the angle of incidence a in the case of a regular surface 2a there will be a specific ratio Rs/Rp, with an Rs component of the radar beams 8a in the polarization plane perpendicular to the surface 2a, and an Rp component of the radar beams 8a in the polarization plane parallel to the surface 2a. Thus, in the case of a fixed angle of incidence a the ratio Rs/Rp can be detected.

Furthermore, generally, also a rotation of the polarization plane of the incident radar beam 8 will occur on the surface 2a, such rotation depending, in particular, also on the surface 2a or, respectively, the properties thereof. Thus, in the measuring arrangement 1 of FIG. 1, the radar beams 18 reflected successively on the surface 2a, the reflector 6 and back again on the surface 2a can be sensed and examined in terms of their polarization. Thus, in a simple embodiment, the radar beam 8 can be put out with different components in perpendicular and parallel polarization, and the intensity or, respectively, signal amplitude of the re-reflected radar beam 18 for the respective polarizations can be detected so as to evaluate the surface 2a. In the event of a rotation what changes is, in particular, also the ratio of the polarization directions Rs and Rp of the reflected radar beam 8a in relation to the incident radar beam 8. Furthermore, in FIG. 1, also a circularly or elliptically polarized radar beam 8 can be used, leading to characteristic reflection behavior.

Thus, optical effects will occur even in the case of regular surfaces 2a which can be determined by virtue of the polarizations. If, in FIG. 1, an irregularity 10 occurs in the detection area caused by defects, impurities or, respectively, inclusions, or material tensions, the reflection behavior of the surface 2a changes. In particular, the polarization of the reflected radar beam 8a is affected. Hereby, the polarization components Rs and Rp may be affected to a different extent, or a specific rotation of a part of the incident radar beam 8 may occur. Thus, even a change in the beam characteristics of the radar beam 18 reflected back to the transceiver 4 may indicate an irregularity; therefore, this detection can initially be made qualitatively, indicating that there is an unusual change and therefore an irregularity 10 in the detection area. Furthermore, a more specific evaluation for the type of material change or, respectively, irregularity can be carried out also.

In the measuring according to FIG. 1, it is also possible to carry out measurements at different angles of incidence a, where, in particular, the ratio Rs/Rp changes depending on the angle of incidence a. Furthermore, the radar beam 8 may be put out at a particular frequency or even broadband. Thus, in principle, measurements at different frequencies or, respectively, frequency ranges are possible also, where irregularities mad lead to different reflection behavior.

Accordingly, instead of the ratio Rs/Rp, the ratio of two other unequal, in particular, orthogonal polarization directions may be evaluated because a polarization direction can be represented as a vector in the respective coordinate system, e.g., Rs/Rp, or also another orthogonal coordinate system.

Thus, the transceiver 4 shown in FIG. 1, upon determining an irregularity can put out a corresponding output signal, whereupon. e.g., a more detailed examination of the detection area can be carried out. Furthermore, this measurement can be compared with a detection provided subsequently, e.g., a radar measurement to determine layer thicknesses.

In the embodiment of FIG. 2, two transceivers 4, 104 are provided, i.e., instead of the reflector 6 a second transceiver 104 with a corresponding alignment of its optical axis B at the same angle of incidence a in relation to the normal N as the first transceiver 4. Here, in principle, it is possible to provide, e.g., just a one-way transmitter instead of the first transceiver 4, and a receiver instead of the second transceiver 104, so that a detection is carried out one-way. Thus, in the detection it is possible to directly detect reflected radar beam 8a by means of the second transceiver 104. The respective measuring can also be carried our reversely, with a actively emitting second transceiver 104 and a detecting first transceiver 4. Hereby, a synchronization of the transceivers 4, 104 may be provided; in principle, however, a synchronization is not required because no precise times of flight must be determined but rather a change of the received beam characteristics.

FIG. 3 shows the signal amplitude (or intensity) of the component of the reflected radiation Rp parallel to the surface 2a, where I indicates the signal amplitude without irregularity and II the signal amplitude with an exemplary irregularity; FIG. 4 shows the corresponding representation of the component of the reflected radiation Rs with a polarization plane perpendicular to the surface 2a. The ideal reflection behavior on a planar, undisturbed surface 2a leads to the partial suppression of the perpendicular incident radiation, i.e., a smaller value of Rs and a relatively large component of the parallel incident radiation Rp. According to FIG. 3, an irregularity reduces the value of Rp, and according to FIG. 4, the value of Rs is increased. Additionally, a change of the overall signal amplitude or, respectively, intensity can be measured.

In the arrangements of FIGS. 1 and 2, the angle of incidence a may also be chosen as Brewster angle aB, where aB=arctan (n2/n1), with n2 as refractive index of the extruded product 2 and n1 as refractive index of the surrounding air, i.e., n1 approximately equaling 1. In this arrangement, polarized radar radiation is not reflected in the plane of incidence, i.e., Rp=0 or, respectively, essentially 0, so that a change will be highly significant. Hereby, frequently, another polarization will occur at material particularities, in particular, material defects. Hereby, the share of Rs may increase. Because the value of Rp starting from 0 is increased significantly the ratio Rp/Rs is changed considerably so that even small changes can be detected. Thus, the contrast of Rs or, respectively, the ratio Rp/Rs is very high on irregularities so that a significant detection is possible.

FIG. 5 shows a measuring arrangement 201 in transmission, including tow transceivers 4, 104. Thus, the first transceiver 4 again emits its radar beam 8 at the angle of incidence a in relation to the normal N onto the surface 2a, which is diffracted on the surface 2a in the direction towards the normal N, because the refractive index n2 is larger than n1 of air. Subsequently, upon exiting the lower surface 2b the beam is re-diffracted accordingly and detected as transmitted radar beam 28 by the second transceiver 104. Thus, in this assembly in transmission, the entire volume area of the extruded product 2 can be measured, not only the regional surface 2a taking part in the reflection. In this measuring arrangement, too, a change of the polarization of the transmitted beam 28 will occur on material irregularities 10 or, respectively, material defects in the extruded product 2. With Ts as the component of the transmitted beam 28 with the polarization plane perpendicular to the surface 2b, and Tp the component of the transmitted radar beam 20 with the polarization plane parallel to the surface 2a and 2b, again changes according to Tp/Ts or Ts/Tp. In particular, the contrast of Ts on defects will be high. FIG. 6 shows a corresponding measuring arrangement with a transceiver 4 and a reflector 6 provided below the extruded product 2, i.e., a measuring arrangement according to FIG. 1, so that the emitted radar beam 8 after transmission is reflected on the reflector 6 as transmitted radar beam 28 and travels back through the measured object 2 to the transceiver 4 where it is detected. Since the extruded product 2 is passed two times changes can be detected more strongly.

FIG. 7 shows a measuring using a measuring arrangement 1 according to FIG. 1, wherein in this case the second reflection 26 on the lower surface 2b is viewed in addition. Thus, in addition to the reflection on the first surface 2a or, respectively, upper side, as shown in FIG. 1, a diffraction—shown here as parallel or, respectively, as offset—occurs on the surface 2a towards the inside, a second reflection 26 on the inside of the second surface 2b, and subsequently again from the inside partially an exit upwards through the surface 2a, shown here as radiation 18a. Accordingly, the radiation 8a reflected directly on the surface 2a is reflected on the reflector 6 and partially diffracted on the surface 2a towards the inside, reflected upwards as further reflection 27 and upon exiting the surface 2a diffracted towards the outside to the transceiver 4, each having a beam path in the air at the angle of incidence a.

Thus, in this case, second reflection peaks occur which, in this geometry, in particular, should have equal times of flight and are therefore detected as a common second reflection peak, further subsequent reflection peaks decreasing in intensity by virtue of multiple reflections, where in particular, the common second reflection peak can still be detected by the transceiver 4 in the case of thin extruded products 2. Thus, this allows even an irregularity 10 within the extruded product 2 or even at the lower surface 2b to be detected.

This measurement can, according to FIG. 7, be carried out in the measuring arrangement of FIG. 1, and, according to FIG. 8, in the measuring arrangement of FIG. 2 in two transceivers 4, 104.

FIGS. 9 and 10 show the measuring of a corrugated pipe 102, where in this case initially the measuring of one of the surfaces is shown. In FIG. 9 one the left side, links initially the measuring with two transceivers 4, 104 and a sensor alignment at a fixed angle a is shown. Here, according to the specific surface shape, there will be different angles of incidence in different regions. On the right side thereof, a measuring with two transceivers 204 and 304 as well as one reflector 6 is shown producing signals in specific angular alignments to the surface so that troughs 102-1, here e.g., with a planar surface, and crests 102-2 can be detected. By evaluating the different polarizations, e.g., even of two differently polarized signals, it is possible to determine the surface angle or, respectively, the surface curvature. Furthermore, it is also possible to measure the contour profile of the structures. In particular, the first measurement allows for an optimum, rectangular coupling for a subsequent measuring of wall thicknesses with transceiver 104, 304 that are aligned perpendicular to the corrugated pipe 102.

Accordingly, FIG. 10 also shows a measuring in transmission which, consequently, is able to detect even structures near the upper side and underside of a corrugated pipe 102.

In the embodiment of FIG. 11, in addition to the measuring arrangement of FIG. 1, two optical elements 30, 31 are provided. The optical elements 30, 31 affect the polarization, where various effects can be utilized here. Thus, the elements 30, 31 e.g., may be polarization filters filtering or, respectively, passing specific polarization directions and blocking the polarization direction or, respectively, polarization plane perpendicular here to. Further, the optical elements 30, 31 may be designed as delay plates, e.g., λ/2 or λ/4 plates, delaying the incident radar beam 8 to different degrees at different polarizations so that the radar beam 8 or, respectively, 8a is changed specifically. This even allows, e.g., for a partial compensation of a rotation on the surface 2a.

Furthermore, corresponding arrangements including optical means 30, 31 are possible which may be, e.g., actively influenceable, e.g., rotating the polarization by means of a magnetic field applied along the optical axis B (Faraday effect).

### LIST OF REFERENCE NUMERALS

1, 101, 201 measuring arrangement
2 extruded product
2a first surface (top side)
2b second surface (underside)
3 radar measuring device
4 radar transceiver
6 reflector
8 emitted radar beam
8a reflection beam
10 irregularity in detection area
18 reflection beam
26 second reflection
27 further second reflection
28 transmitted radar beam
30 first optical element
31 second optical element
104 second radar transceiver
A optical axis
B optical axis of the reflection or transmission
n1 refractive index in the surrounding air
n2 refractive index in the extruded product
V transport velocity
P1 first polarization
P2 second polarization
Rs component of the reflected radiation with polarization plane perpendicular to the surface 2a
Rp component of the reflected radiation with polarization plane parallel to the surface 2a
N normal
a angle of incidence
Ts component of the transmitted radiation with polarization plane perpendicular to the surface 2a
Tp component of the transmitted radiation with polarization plane parallel to the surface 2a
204, 304 transceivers
102 corrugated pipe
102-1 trough
102-2 crest

1. (canceled)

2. A method for detecting irregularities in measured objects, wherein
a frequency modulated first radar radiation having a first polarization is generated and irradiated along an optical axis onto a measured object, the measured object being at last partially permissive for the radar radiation, and
a frequency modulated second radar radiation having a second polarization reflected and/or transmitted by the measured object is detected, and
irregularities in the measured object are determined from a comparison of the second polarization with the first polarization.

3. The method of claim 2, wherein of the frequency modulated first radar radiation with the first polarization and of the reflected and/or transmitted frequency modulated second radar radiation with the second polarization, components each of a first polarization plane and a second polarization plane orthogonal here to, and/or of opposite circular polarizations are determined, and the components and/or a ratio of the components are formed and evaluated.

4. The method of claim 3, wherein of the emitted first radar radiation and the reflected or transmitted second radar radiation, each the components of a polarization plane perpendicular to a surface of the measured object and a polarization parallel to the surface of the measured object are determined, where the components and/or a ratio of the components are compared with one another.

5. The method of claim 4, wherein a ratio of the radiation of the perpendicular polarization and the parallel polarization both of the first emitted radar radiation as well as of the transmitted or reflected second radar radiation is determined, and the two ratios are evaluated, in particular, compared with one another, and/or a ratio of the radiation with perpendicular polarization of the first radar radiation to the radiation with perpendicular polarization of the second radar radiation is determined and, correspondingly, a ratio of the radiation with parallel polarization of the first radar radiation to the radiation with parallel polarization of the second radar radiation is determined, and the ratios are evaluated.

6. The method of claim 2, wherein the frequency modulated THz radiation is formed as FMCW radiation.

7. The method of claim 2, wherein one or more of the following characteristics are determined as irregularities: defects, material changes, surface changes, material tensions, inclusions, impurities.

8. The method of claim 4, wherein the frequency modulated first radar beams are irradiated from a radar measuring device onto the surface of the measured objects, and the measured object is continuously adjusted relative to the radar measuring device in a direction of transport and/or at a transport velocity, and the irregularities in the measured object are deduced from am evaluation of the temporal behavior of the detected reflected and/or transmitted radar beams, e.g., by virtue of a change of the ratio of the polarizations of the reflected and/or transmitted radar beams.

9. The method of claim 4, wherein radar beams are detected and evaluated which have been reflected multiple times between the surfaces of the measured object, where the multiple reflected radar beams are discerned from the radar beams that have not been reflected multiple times on the basis of a time-of-flight delay.

10. The method of claim 2, wherein the emitted radar radiation and the reflected or transmitted radar radiation is influenced in its polarization, in particular, using optical rotating means and/or polarization filters, in particular, to change the ratio of the components in different polarization directions.

11. The method according to claim 2, wherein what is measured as measured object is a plastic product, in particular, an extruded product post extrusion, preferably a continuous extruded product.

12. A radar measuring device for detecting defects in measured objects, the radar measuring device comprising:
a first optical unit which is designed as an emitter and/or first transceiver in such a way that it emits frequency modulated radar radiation with a first polarization along a first optical axis, and
a second optical unit designed as a receiver and/or second transceiver and/or reflector with a second optical axis,
the radar measuring device being designed to carry out a method according to one of the above claims.

13. The radar measuring device of claim 12, wherein the first optical unit and the second optical unit are aligned such that their optical axes intersect, for measuring a measured object in the area of the intersecting axes.

14. The radar measuring device of claim 12, wherein the second optical unit is designed as a reflector, the second optical axis of which is aligned such that the reflector reflects back perpendicularly radar radiation emitted from the first transceiver and transmitted and/or reflected on the measured object.

15. The radar measuring device of claim 12, wherein the radar measuring device comprises an optical means for influencing the polarization, in particular, one or more polarization filter(s) and/or one or more means optically rotating the polarization directions, e.g., λ/2 plates and/or λ/4 plates.

16. A measuring arrangement, comprising a radar measuring device of claim 12 and the measured object, in particular, extruded product, adjusted relative to the radar measuring device at a transport velocity.
